(19) United States
(12) Patent Application Publication
(10) Pub. No.: US 2018/0259781 A1
(43) Pub. Date: Sep. 13, 2018

(54) IMMERSIVE INTERACTIVE GLASSES

(71) Applicant: Brogent Technologies Inc., Kaohsiung City (TW)

(72) Inventors: Chih-Hung OU YANG, Kaohsiung City (TW); An Kiang, Kaohsiung City (TW); Dah-Cheng WENG, Kaohsiung City (TW)

(21) Appl. No.: 15/456,745

(22) Filed: Mar. 13, 2017

(51) Int. Cl. G02B 27/22; G02B 27/01; G06T 15/08; G06T 19/00; G08C 23/04; H04N 5/265; H04N 13/02; H04N 13/04; H04N 21/2343

(52) U.S. Cl. CPC G02B 27/2271; G02B 27/017; G06T 15/08; G06T 19/006; G08C 23/04; G06T 2215/16; H04N 13/0296; H04N 13/0497; H04N 21/23439; G02B 27/22; G06T 2215/12; H04N 5/265

(57) ABSTRACT

Immersive interactive glasses include a frame body, a display host, a connecting module and at least one adjustable light-transmitting screen. The frame body includes a hollow frame, and the hollow frame has a front opening, a rear opening and a plurality of side profiles. The display host in the front opening includes a microcontroller unit (MCU). The connecting module includes a connector electrically connected with the MCU. The adjustable light-transmitting screen is electrically connected with the connector and disposed in one of the side profiles. The immersive interactive glasses controls transmission of light through the adjustable light-transmitting screen by the MCU in order to increase interactivity and ensure safety in use.

### TECHNICAL FIELD

The present invention relates to three-dimensional (3D) glasses and, in particular, to head-mounted 3D glasses.

### BACKGROUND

Virtual Reality (VR) is also called virtual reality environment, which uses computer to simulate a three-dimensional environment and simulate a user's physical presence in this world, including simulating the user's perception of sight, thereby achieving a realistic and immersive simulation of the three-dimensional environment. When the user moves to change his position, the computer can perform computing functions and send back accurate three-dimensional images so as to provide to the user a realistic experience.

However, in conventional technologies, the three-dimensional images are mostly generated by the computer, and thus the user cannot sufficiently interact with the outside world and the real-world environment, which is a disadvantage. Hence, the present invention aims to improve the aforesaid disadvantage of the VR and enhance interactivity with the real-world environment, by using the augmented reality (AR) technology which is capable of obtaining images from cameras at different positions and different angles at real time and adding related images.

Accordingly, in order to solve the above disadvantages, the present inventor studied related technology and provided a reasonable and effective solution in the present disclosure.

### SUMMARY

It is an object of the present invention to provide immersive interactive glasses which controls transmission of light through an adjustable light-transmitting screen, thereby enhancing a wearer's interactivity between a virtual reality environment and a real-world environment.

It is another object of the present invention to provide immersive interactive glasses which can be used for virtual reality and augmented reality, providing an integrated-type display method.

It is still another object of the present invention to provide immersive interactive glasses which can be used in interactive games and can switch between virtual reality and augmented reality according to scenarios or other application requirement for a realistic experience and enhanced interactivity and safety.

Accordingly, the present invention relates to immersive interactive glasses. The immersive interactive glasses include a frame body, a display host, a connecting module, and at least one adjustable light-transmitting screen. The frame body includes a hollow frame; the hollow frame includes a front opening, a rear opening opposite to the front opening, and a plurality of side profiles between the front opening and the rear opening. The display host is disposed in the front opening, and the display host includes a microcontroller unit. The connecting module includes at least one connector electrically connected with the microcontroller unit. The adjustable light-transmitting screen is electrically connected to the connector and is disposed in one of the side profiles. The immersive interactive glasses controls transmission of light through the adjustable light-transmitting screen by means of the microcontroller unit.

Compared to conventional techniques, the adjustable light-transmitting screen of the immersive interactive glasses is electrically connected to the microcontroller unit, at least one adjustable light-transmitting screen is disposed in the side profiles. When the immersive interactive glasses are in use, transmission of light through the adjustable light-transmitting screen can be controlled, thereby a lateral viewing range can be increased or a wearer's view of a surrounding environment can be occluded. Furthermore, the adjustable light-transmitting screen can also display related information, thus enhancing interactivity between a virtual reality environment and a real-world environment, and improving practicability.

### BRIEF DESCRIPTION OF THE DRAWINGS

The disclosure will become more fully understood from the detailed description, and the drawings given herein below is for illustration only, and thus does not limit the disclosure, wherein:

FIG. 1 is a schematic in-use view illustrating that immersive interactive glasses of the present invention is worn by a wearer;

FIG. 2 is a perspective exploded view illustrating the immersive interactive glasses;

FIG. 3 is a diagram illustrating the immersive interactive glasses;

FIG. 4 is a schematic view illustrating the immersive interactive glasses in use;

FIG. 5 is another schematic view illustrating the immersive interactive glasses in use; and

FIG. 6 is still another schematic view illustrating the immersive interactive glasses in use.

### DETAILED DESCRIPTION

Detailed descriptions and technical contents of the present invention are illustrated below in conjunction with the accompany drawings. However, it is to be understood that the descriptions and the accompany drawings disclosed herein are merely illustrative and exemplary and not intended to limit the scope of the present invention.

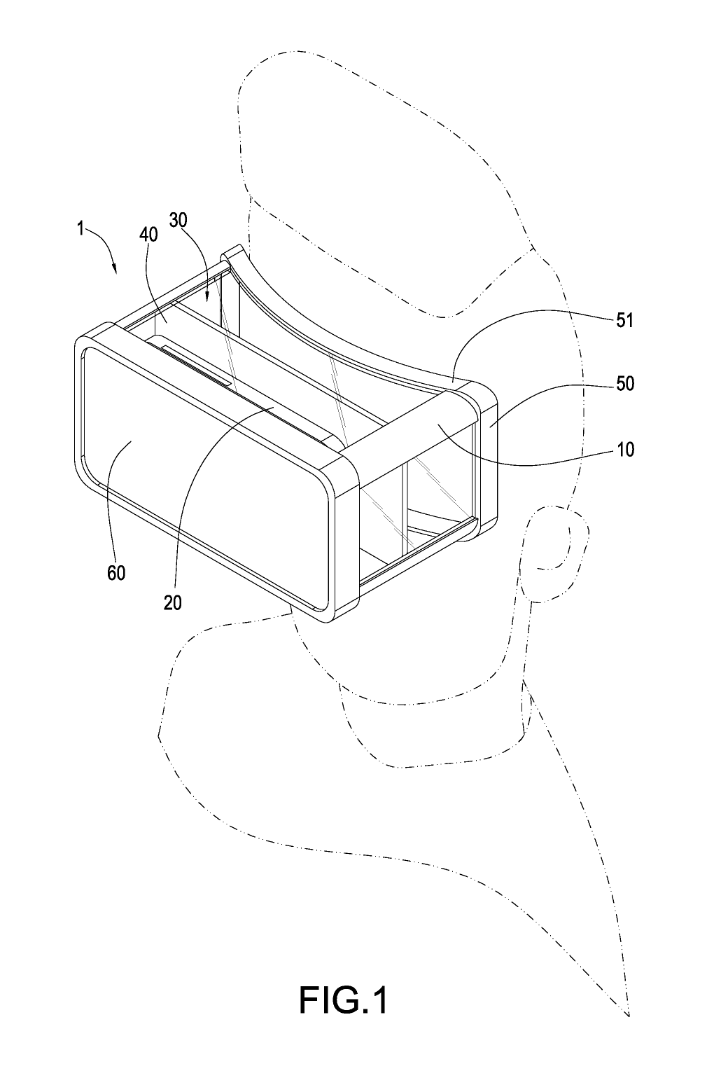

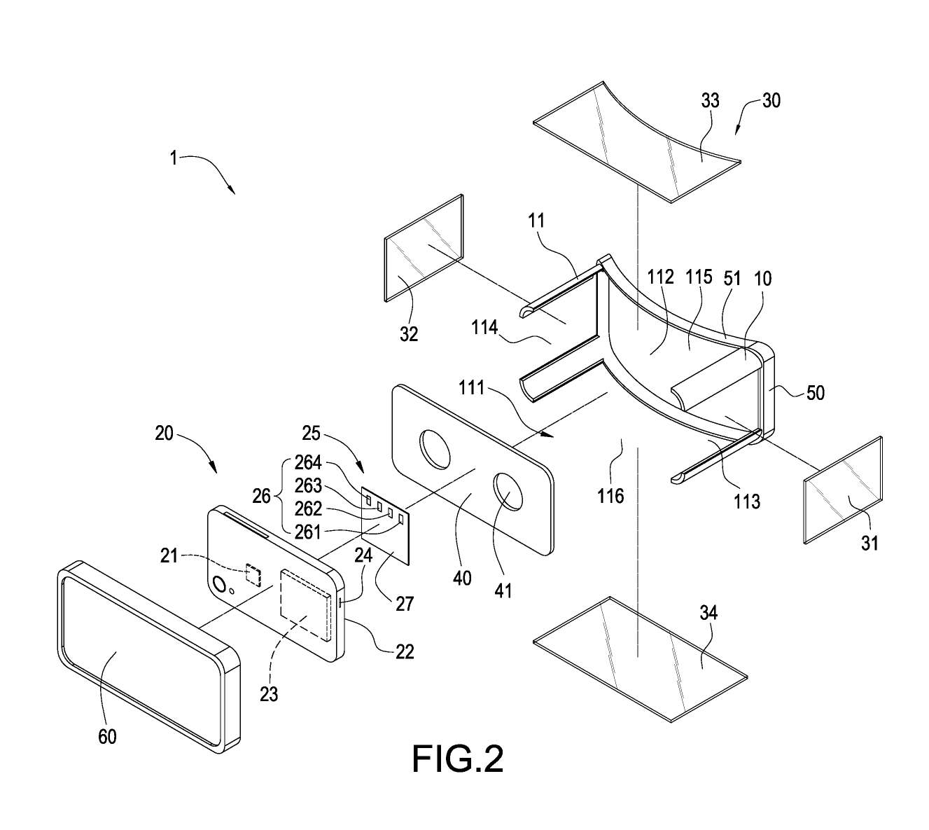

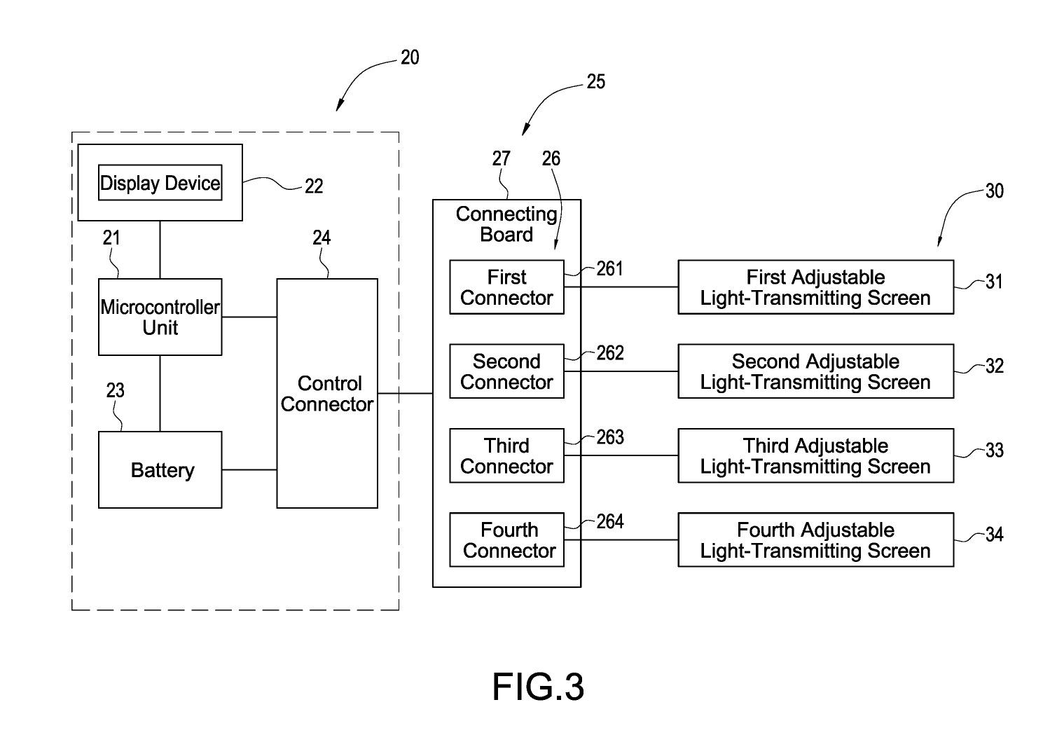

Please refer to FIGS. 1 to 3 which are a schematic in-use view, a perspective exploded view and a diagram illustrating immersive interactive glasses of the present invention. As shown in FIG. 1, the immersive interactive glasses 1 are mounted in front of a wearer's eyes. In practice, the immersive interactive glasses 1 are fastened to the wearer by using a tying band or are hung to the wearer. Referring to FIG. 2, the immersive interactive glasses 1 include a frame body 10, a display host 20, a connecting module 25, and at least one adjustable light-transmitting screen 30. The adjustable light-transmitting screen 30 is disposed in a lateral side (a front side is in front of the wearer's eyes, and the lateral side herein is laterally positioned with respect to the front side) of the frame body 10. The display host 20 is disposed inside the frame body 10 and controls transmission of light through the adjustable light-transmitting screen 30. Accordingly, transmission of light through the immersive interactive glasses 30 can be controlled to improve interactivity in use and to ensure safety in use. The structure of the immersive interactive glasses 1 is detailed hereinafter.

The frame body 10 includes a hollow frame 11. The hollow frame 11 includes a front opening 111 (in front of the wearer's eyes) and a rear opening 112 opposite to the front opening 111, a plurality of side profiles 113 to 116 between the front opening 111 and the rear opening 112. To be specific, the side profiles 113 to 116 include a left profile 113, a right profile 114, a top profile 115 and a bottom profile 116. It is preferable that the hollow frame 11 is of rectangular shape, and the front opening 111 and the rear opening 112 are of rectangular shape.

The display host 20 is disposed in the front opening 111. The display host 20 includes a microcontroller unit 21, a display device 22 electrically connected to the microcontroller unit 21, a battery 23 and a control connector 24. In the present embodiment, the microcontroller 21, the display device 22, the battery 23 and the control connector 24 together form an integral mobile phone.

Moreover, the connecting module 25 includes at least one connector 26 electrically connected with the microcontroller unit 21. In the present embodiment, the connecting module 25 further includes a connecting board 27 disposed with the connector 26, and the connecting module 25 is disposed as one separate unit at one side of the display host 20.

In the present embodiment, the at least one adjustable light-transmitting screen 30 is disposed in one of the side profiles 113 to 116 of the frame body 10, the power of the adjustable light-transmitting screen 30 is supplied by the battery 23 of the display host 20. Furthermore, when the adjustable light-transmitting screen 30 is not powered on (i.e. power is not yet supplied thereto), it is opaque. At this point, the adjustable light-transmitting screen 30 can occlude the wearer's view of a surrounding environment, so the wearer can experience virtual reality, i.e. a realistic and immersive simulation of a three-dimensional environment. On the contrary, when the adjustable light-transmitting screen 30 is powered on (i.e. power is supplied thereto), it is transparent or displays related information (e.g. providing information of the surrounding environment) for the wearer for safety purpose.

Moreover, the adjustable light-transmitting screen 30 is electrically connected to the microcontroller unit 21 via the connector 26, so that the immersive interactive glasses 1 can control transmission of light through the adjustable light-transmitting screen 30 by means of the microcontroller unit 21. The microcontroller unit 21 decides whether to supply power to the adjustable light-transmitting screen 30.

In practice, when the microcontroller unit 21 decides not to supply power to the adjustable light-transmitting screen 30, the microcontroller unit 21 breaks the electrical connection between the battery 23 and the control connector 24. At this point, the connector 26 cannot be electrically connected to the battery 23 through the control connector 24, and the battery 23 cannot supply power to the adjustable light-transmitting screen 30. As a result, the adjustable light-transmitting screen 30 is opaque because it is not powered on. Furthermore, when the microcontroller unit 21 decides to supply power to the adjustable light-transmitting screen 30, the microcontroller unit 21 controls the battery 23 to be electrically connected to the control connector 24. At this point, the connector 26 is connected to the battery 23 via the control connector 24, the battery 23 can supply power to the adjustable light-transmitting screen 30, and the adjustable light-transmitting screen 30 is transparent or displays related information because it is powered on.

The adjustable light-transmitting screen 30 is a polymer dispersed liquid crystal display device (PDLC) or a transparent display screen. It is preferable that there are multiple adjustable light-transmitting screens 30, and the multiple adjustable light-transmitting screens 30 are disposed in the top profile 115, the bottom profile 116, the left profile 113, or the right profile 114 of the hollow frame 11.

In detail, a game program is installed in the display host 20; the game program includes at least one screen control command, and the microcontroller unit 21 controls transmission of light through the adjustable light-transmitting screen 30 according to the screen control command.

In the present embodiment, multiple adjustable light-transmitting screens 30 are coupled to the hollow frame 11 and they include a first adjustable light-transmitting screen 31, a second adjustable light-transmitting screen 32, a third adjustable light-transmitting screen 33, and a fourth adjustable light-transmitting screen 34. That is to say, the first adjustable light-transmitting screen 31 is disposed in the left profile 113 of the hollow frame 11, the second adjustable light-transmitting screen 32 is disposed in the right profile 114, the third adjustable light-transmitting screen 33 is disposed in the top profile 115, and the fourth adjustable light-transmitting screen 34 is disposed in the bottom profile 116.

In the present embodiment, the connector 26 includes a first connector 261, a second connector 262, a third connector 263 and a fourth connector 264. The first to fourth adjustable light-transmitting screens 31 to 34 are electrically connected to the control connector 24 through the first to fourth connectors 261 to 264, so that the microcontroller 21 can control transmission of light through the first to fourth adjustable light-transmitting screens 31 to 34 by means of the control connector 24, and thereby a viewing range from each profile can be increased or the wearer's view of the surrounding environment can be occluded to avoid distractions.

In the present embodiment, the immersive interactive glasses 1 further include a window division plate 40, a protection frame 50 and a protection cover 60. The window division plate 40 is disposed between the front opening 111 and the rear opening 112 and includes two sight holes 41, and a distance between the two sight holes 41 is corresponding to a distance between two eyes of the wearer. The protection frame 50 is coupled to the rear opening 112 and is disposed outside the window division plate 40, and the protection cover 60 covers the front opening 111 and is disposed outside the display host 20. It is preferable that one side of the protection frame 50 includes a curved plate 51 for being in contact with a forehead of the wearer.

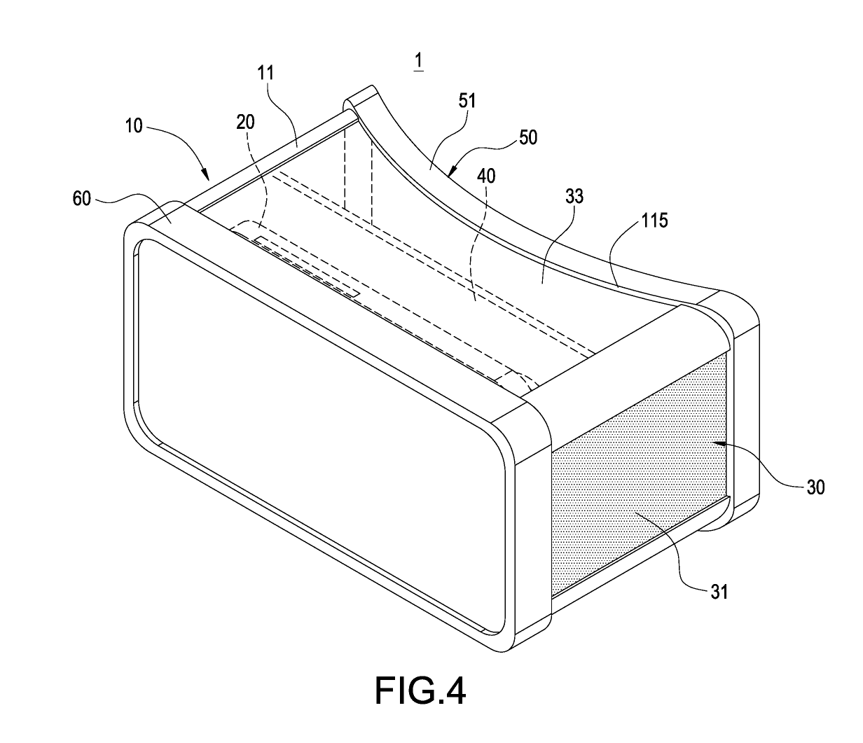

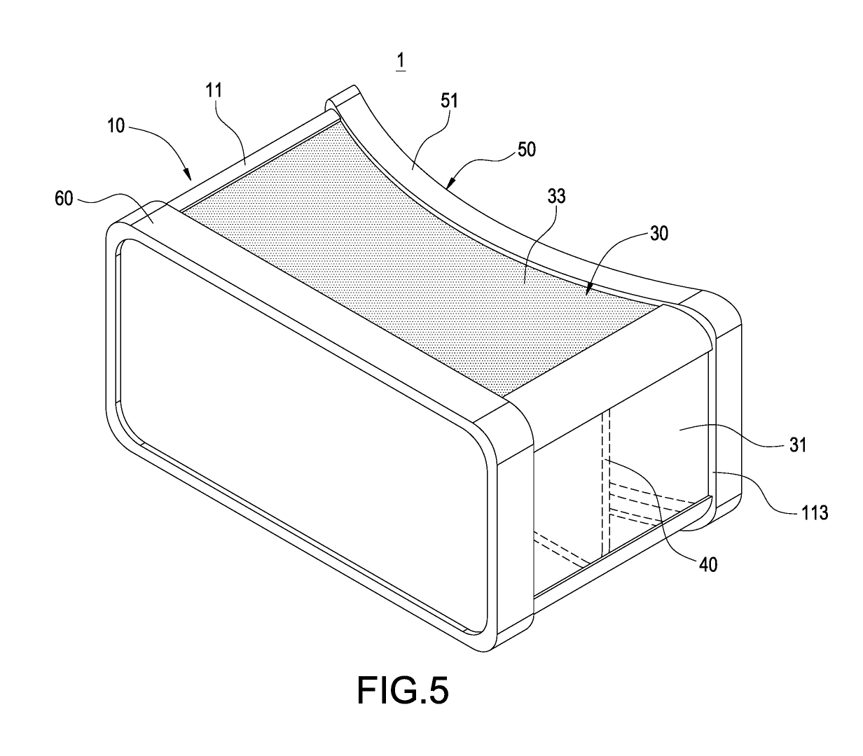

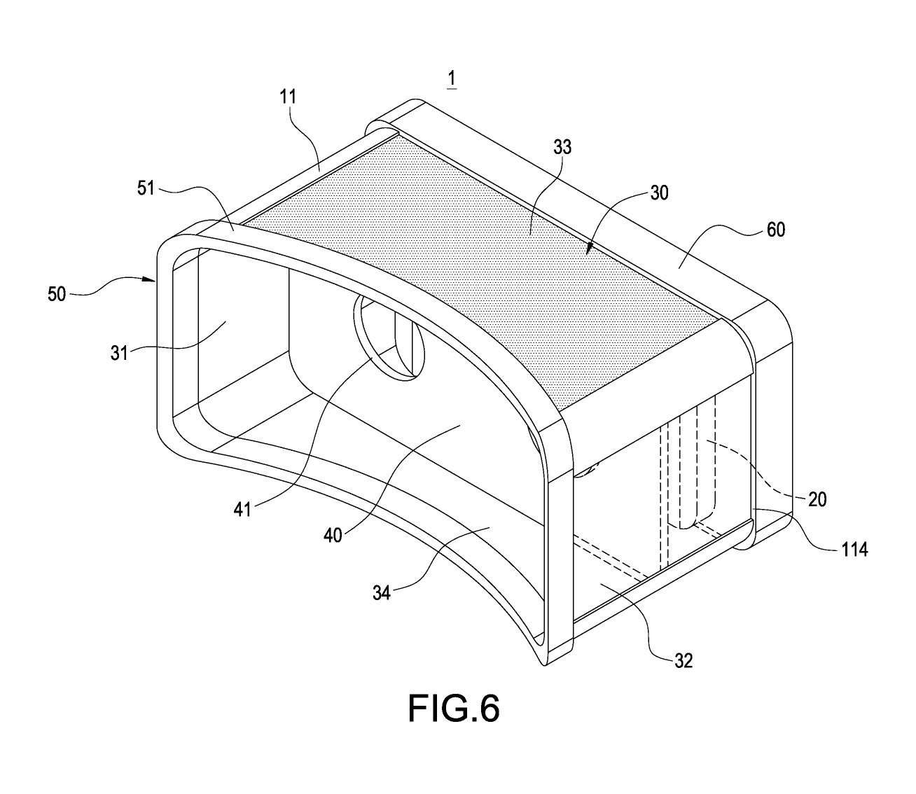

Please refer to FIGS. 4 to 6 which are schematic views illustrating the immersive interactive glasses in use. As shown in FIG. 4, the immersive interactive glasses 1 control the third adjustable light-transmitting screen 33 in the top profile 115 to be transparent. Therefore, the third adjustable light-transmitting screen 33 is transparent to allow the wearer to have an increased viewing range from the top profile 115. Similarly, as shown in FIG. 5, the immersive interactive glasses 1 control the first adjustable light-transmitting screen 31 in the left profile 113 to be transparent, so the first adjustable light-transmitting screen 31 allows the wearer to have an increased viewing range from the left profile 113. Further, referring to FIG. 6, the immersive interactive glasses 1 control the second adjustable light-transmitting screen 32 in the right profile 114 to be transparent, so the second adjustable light-transmitting screen 32 allows the wearer to have an increased viewing range from the right profile 114.

It should be noted that, in practice, the immersive interactive glasses 1 can control the multiple adjustable light-transmitting screens 30 to be transparent, to occlude the view of the surrounding environment or to display information, according to requirement.

Moreover, a game program is installed in the display host 20; the game program includes at least one screen control command, and the microcontroller unit 21 controls transmission of light through the adjustable light-transmitting screen 30 according to the screen control command. Therefore, the immersive interactive glasses 1 can be used in interactive games. When a player is playing an interactive game having scenarios, the microcontroller unit 21 of the immersive interactive glasses 1 can control whether the adjustable light-transmitting screen 30 at any side profile is transparent or displays related information according to the screen control command.

To be specific, when the scenarios need complete virtual images, the microcontroller unit 21 controls the adjustable light-transmitting screen 30 to be opaque so as to occlude the wearer's view of the surrounding environment, and thereby the player can be immersed in a virtual world. When the scenarios need images of the surrounding environment or have other safety considerations, the microcontroller unit 21 controls the adjustable light-transmitting screen 30 to be transparent or to provide information of the surrounding environment to the player. Thus, a better interactive effect in the interactive games can be achieved, and the player can be interactive between the virtual reality world and the real-world environment.

It is to be understood that the above descriptions are merely the preferable embodiments of the present invention and are not intended to limit the scope of the present invention. Equivalent changes and modifications made in the spirit of the present invention are regarded as falling within the scope of the present invention.

What is claimed is:

1. An immersive interactive glasses, comprising:
a frame body, the frame body including a hollow frame, the hollow frame including a front opening, a rear opening opposite to the front opening, and a plurality of side profiles surroundingly disposed between the front opening and the rear opening;
a display host disposed in the front opening, the display host including a microcontroller unit;
a connecting module, the connecting module including at least one connector electrically connected to the microcontroller unit; and
at least one adjustable light-transmitting screen, the adjustable light-transmitting screen being electrically connected to the connector and disposed in one of the side profiles, the immersive interactive glasses controlling transmission of light through the adjustable light-transmitting screen by means of the microcontroller unit.

2. The immersive interactive glasses of claim 1, wherein the hollow frame is of rectangular shape, and the front opening and the rear opening are of rectangular shape.

3. The immersive interactive glasses of claim 1, wherein the display host further includes a display device electrically connected to the microcontroller unit, a battery, and a control connector, and the adjustable light-transmitting screen is electrically connected to the microcontroller unit through the control connector.

4. The immersive interactive glasses of claim 3, wherein the connecting module further includes a connecting board disposed with the connector, the connecting module is disposed as one separate unit at one side of the display host.

5. The immersive interactive glasses of claim 1, wherein a game program is installed in the display host, the game program includes at least one screen control command, and the microcontroller unit controls transmission of light through the adjustable light-transmitting screen according to the screen control command.

6. The immersive interactive glasses of claim 1, wherein the adjustable light-transmitting screen is a polymer dispersed liquid crystal display device or a transparent display screen.

7. The immersive interactive glasses of claim 1, wherein the immersive interactive glasses includes multiple adjustable light-transmitting screens, the side profiles include a left profile, a right profile, a top profile, and a bottom profile, and the adjustable light-transmitting screens are disposed in the top profile, the bottom profile, the left profile, or the right profile.

8. The immersive interactive glasses of claim 1, further comprising a window division plate, the window division plate being disposed between the front opening and the rear opening and including two sight holes, and a distance between the two sight holes is corresponding to a distance between two eyes of a wearer.

9. The immersive interactive glasses of claim 1, further comprising a protection frame and a protection cover, the protection frame being coupled to the rear opening and being disposed outside the window division plate, and the protection cover covering the front opening and being disposed outside the display host.

10. The immersive interactive glasses of claim 9, wherein one side of the protection frame includes a curved plate for being in contact with a forehead of a wearer.
